(19) United States
(12) Patent Application Publication
(10) Pub. No.: US 2004/0167264 A1
(43) Pub. Date: Aug. 26, 2004

(54) Impact-strength-modified polymer compositions

(76) Inventors: Marc Vathauer, Koln (DE); Gerwolf Quaas, Koln (DE); Thomas Braig, Dusseldorf (DE); Detlev Joachimi, Krefeld (DE)

Correspondence Address: BAYER POLYMERS LLC, 100 BAYER ROAD, PITTSBURGH, PA, 15205, US

(21) Appl. No.: 10/719,403

(22) Filed: Nov. 21, 2003

(30) Foreign Application Priority Data
Nov. 25, 2002 (DE) 10254877.3
Dec. 6, 2002 (DE) 10257077.9

(51) Int. Cl. C08L 51/00

(52) U.S. Cl. 524/401; 524/449; 524/451; 525/66

(57) ABSTRACT

A thermoplastic polyamide molding composition having improved impact strength is disclosed. The composition contains polyamide, an electrically conductive carbon in particulate form and a graft polymer. In one preferred embodiment the composition further contains mineral particles. The composition is especially suitable for direct online lacquering without the necessity for pre-treatment of the molding with an electrically conductive primer system.

### FIELD OF THE INVENTION

The invention relates to thermoplastic molding compositions and more particularly to impact strength-modified polyamide compositions.

### SUMMARY OF THE INVENTION

A thermoplastic polyamide molding composition having improved impact strength is disclosed. The composition contains polyamide, an electrically conductive carbon in particulate form and a graft polymer. In one preferred embodiment the composition further contains mineral particles. The composition is especially suitable for direct online lacquering without the necessity for pre-treatment of the molding with an electrically conductive primer system.

### TECHNICAL BACKGROUND OF THE INVENTION

DE-A 101 019 225 describes generally polymer compositions containing polyamide, graft polymer, vinyl (co)polymer, compatibility promoter and ultrafine mineral particles with anisotropic particle geometry. The composition according to the present invention is a selection with regard to this disclosure. In DE-A 101 019 225 it is not mentioned that the compositions described therein can be lacquered online.

Polymer blends consisting of a polyamide, a styrene/acrylonitrile copolymer and a compatibility promoter are known from EP 0 202 214 A. A copolymer formed from a vinyl aromatic monomer and acrylonitrile, methacrylonitrile, C₁ to C₄ alkyl methacrylate or C₁ to C₄ alkyl acrylate in a weight ratio from 85:15 to 15:85 is employed by way of compatibility promoter. Through the use of compatibility promoters, an enhanced impact strength is to be obtained. A disadvantage of the polymer blends described in this printed publication is that they exhibit too low a stiffness and too high a coefficient of expansion for thin-wall applications.

From JP 11 241 016.A2 polyamide molding compositions are known that contain, in addition to polyamide, rubber-modified styrene polymers, graft polymers based on ethylene/propylene rubbers and talc with a particle diameter from 1 μm to 4 μl.

EP-A 0 718 350 describes polymer blends consisting of a crystalline and an amorphous or semicrystalline polymer and also 2 to 7 wt. % electrically conductive carbon (carbon black) for the production of moulded, thermoplastic objects which are lacquered electrostatically in a further step. Particularly highly thermally stable polymer blends with a conductive finish are not described in this document.

In U.S. Pat. No. 4,974,307 a method is described for producing an automobile body from metal and plastic, which is then lacquered. To this end, molding compositions and moldings produced therefrom consisting of a polymer resin and a conductive material are described, the surface resistivities of which are between 5×10²Ω×cm and 1×10⁶Ω×cm. In order to obtain these high conductivities, a large addition of conductivity additive is required, which has a negative influence on flowability and toughness of the corresponding polymer molding composition.

Generally known, furthermore, is the use of fine-particle inorganic materials in certain polymer compositions, particularly in polycarbonate compositions. The inorganic materials are employed in these compositions, for example, as reinforcing material for the purpose of increasing the stiffness and tensile strength, for the purpose of enhancing the dimensional stability in the event of fluctuations in temperature, for the purpose of improving the surface properties or—in flame-resistant materials—also as flameproofing synergist. Use is made both of mineral materials and of synthetically prepared materials. Thus in U.S. Pat. No. 5,714,537, for example, polycarbonate blends are described which contain certain inorganic fillers for the purpose of improving the stiffness and resistance to linear thermal expansion.

From EP 0 785 234 A1 rubber-modified polymer compositions are known which contain by way of compatibility promoter a terpolymer formed from styrene, acrylonitrile and maleic anhydride. The addition of the compatibility promoters results in an improvement in the mechanical properties, in particular the impact strength at low temperatures. A disadvantage, however, is the fact that the overall profile of properties of the polymer, in particular the processing behavior in the course of injection molding, deteriorates with the addition of the compatibility promoter.

Impact-strength-modified polyethylene-terephthalate/polycarbonate blends that are suitable for online lacquering are known from WO 01/34703. Polyamide blends are not described.

Known for some directly lacquerable online/inline applications is Noryl® GTX, produced by General Electric Plastics (cf. EP-A 685 527). In this case it is a question of a blend containing polyamide and polyphenylene ether (PA/PPO blend).

As a rule, exterior bodywork parts made of plastics have to be lacquered. In the case of plastics that have been stained the color of the car, the bodywork add-on parts produced therefrom are, as a rule, covered with one or more layers of transparent lacquer. In the case of plastics that have not been stained the color of the car, the bodywork add-on parts produced therefrom are lacquered with several layers of lacquer, whereby at least one of the layers is color-imparting (coating lacquer). Depending on the thermal stability of the plastics, a distinction is made here between various processes which differ in the time of attachment of the plastic add-on parts to the exterior bodywork part. If the plastic add-on parts go through the entire lacquering process, one generally speaks of an “online” lacquering, which makes the greatest demand on the thermal stability of the plastic. In the case of so-called “inline” lacquering, the plastic add-on part is mounted onto the exterior bodywork part and introduced into the lacquering line after the so-called cathodic dipping. In the case of so-called “offline” lacquering, the entire plastic add-on part is lacquered outside the lacquering line at low temperatures and is only subsequently mounted onto the exterior bodywork part. The online process is preferred by the automobile industry, since it minimizes the working steps, and, besides, the best color matching of plastic and sheet metal is obtained. With this process, temperatures of up to 205° C. are attained, so great demands are made on the thermal stability of the molding.

If it is possible to modify a plastic in such a way that its specific resistivity becomes so low that it may be used in the electrostatic lacquering without previous treatment with a conductive primer system, one production step is bypassed.

Additional demands which are made on the bodywork add-on parts made of plastic are good stiffness, low thermal expansion, good surface quality, good lacquerability and good resistance to chemicals. In addition, the molding compositions that are used for producing the exterior bodywork parts must exhibit good flowability in the molten state.

It was the object of the present invention to make available conductive polyamide molding compositions that exhibit excellent thermal stability and low thermal expansion. The compositions according to the invention additionally exhibit an increased tensile strength with, at the same time, good processing behavior.

### DETAILED DESCRIPTION OF THE INVENTION

The present invention therefore provides molding compositions containing polyamide and 0.1 to 8 parts by weight electrically conductive carbon particles and also 0.5 to 50 parts by weight graft polymer.

Preferred is a polymeric molding composition containing

(A) 40 to 90, preferably 45 to 85, particularly preferably 50 to 80, in particular 55 to 70 parts by weight polyamide

(B) 0.5 to 50, preferably 1 to 35, particularly preferably 1 to 30, in particular 5 to 25 parts by weight graft polymer

(C) 0.1 to 30, preferably 1 to 20, particularly preferably 1.5 to 15, in particular 2.5 to 13 parts by weight mineral particles

(D) 0.1 to 8, preferably 1 to 5, particularly preferably 1.5 to 4.5 parts by weight electrically conductive carbon particles.

The composition may contain as further components compatibility promoter (component E) and/or vinyl (co)polymer (component F), polymer additives such as stabilizers, and phenolformaldehyde resins (H).

The invention also provides, moreover, the online-lacquered moldings that may be obtained from the aforementioned compositions.

It has been found that an article molded of the above composition displays excellent thermal stability and that, by reason of the latter, its use in online lacquering processes is highly appropriate. Moreover, the compositions according to the invention exhibit high moduli of elasticity as well as a Class-A surface, high stiffness and outstanding resistance to chemicals.

The components of the polymer composition that are suitable in accordance with the invention are elucidated in exemplary manner below.

Component A

Polyamides (component A) that are suitable in accordance with the invention are known or may be prepared by processes known from the literature.

Polyamides that are suitable in accordance with invention include homopolyamides, copolyamides and mixtures of these polyamides. These may be partially crystalline and/or amorphous polyamides. Suitable as partially crystalline polyamides are polyamide 6, polyamide 66, mixtures and corresponding copolymers formed from these components. Moreover, partially crystalline polyamides the acid component of which consists entirely or partially of terephthalic acid and/or isophthalic acid and/or suberic acid and/or sebacic acid and/or azelaic acid and/or adipic acid and/or cyclohexanedicarboxylic acid and the diamine component of which consists entirely or partially of m- and/or p-xylylenediamine and/or hexamethylenediamine and/or 2,2,4-trimethyl-hexamethylenediamine and/or 2,4,4-trimethylhexamethylenediamine and/or isophoronediamine are suitable.

In addition, suitable polyamides include those that are prepared entirely or partially from lactams with 7 to 12 carbon atoms in the ring, optionally with concomitant use of one or more of the aforementioned initial components.

Particularly preferred partially crystalline polyamides are polyamide 6 and polyamide 66 and their mixtures. Known products may be employed by way of amorphous polyamides. They are obtained by polycondensation of diamines such as ethylenediamine, hexamethylenediamine, decamethylenediamine, 2,2,4- and/or 2,4,4-trimethylhexamethylenediamine, m- and/or p-xylylenediamine, bis(4-aminocyclohexyl)methane, bis(4-aminocyclohexyl)propane, 3,3′-dimethyl-4,4′-diaminodicyclohexylmethane, 3-aminomethyl-3,5,5-trimethylcyclohexylamine, 2,5- and/or 2,6-bis(aminomethyl)norbornane and/or 1,4-diaminomethyl-cyclohexane with dicarboxylic acids such as oxalic acid, adipic acid, azelaic acid, decanedicarboxylic acid, heptadecanedicarboxylic acid, 2,2,4- and/or 2,4,4-trimethyladipic acid, isophthalic acid and terephthalic acid.

Also suitable are copolymers that are obtained by polycondensation of several monomers; further suitable are copolymers that are prepared by addition of aminocarboxylic acids such as ε-aminocaproic acid, ω-aminoundecanoic acid or co-aminolauric acid or their lactams.

Particularly suitable amorphous polyamides are the polyamides prepared from isophthalic acid, hexamethylenediamine and other diamines such as 4,4-diaminodicyclohexylmethane, isophoronediamine, 2,2,4- and/or 2,4,4-trimethylhexamethylenediamine, 2,5- and/or 2,6-bis(aminomethyl)norbornene; or from isophthalic acid, 4,4′-diaminodicyclohexylmethane and ε-caprolactam; or from isophthalic acid, 3,3′-dimethyl-4,4′-diaminodicyclohexylmethane and laurolactam; or from terephthalic acid and the isomer mixture of 2,2,4- and/or 2,4,4-trimethylhexamethylenediamine.

Instead of the pure 4,4′-diaminodicyclohexylmethane, mixtures of the positional isomers diaminodicyclohexylmethanes may also be employed that are composed of

70 to 99 mol % of the 4,4′-diamino isomer,

1 to 30 mol % of the 2,4′-diamino isomer and

0 to 2 mol % of the 2,2′-diamino isomer,

optionally corresponding to more highly condensed diamines that are obtained by hydrogenation of diaminodiphenylmethane of technical quality. The isophthalic acid may be replaced by terephthalic acid in a proportion amounting up to 30%.

The polyamides preferably exhibit a relative viscosity (measured in a 1 wt. % solution in m-cresol at 25° C.) from 2.0 to 5.0, particularly preferably from 2.5 to 4.0.

The polyamides may be contained in component A on their own or in arbitrary mixture with one another.

Component B

Component B comprises one or more rubber-modified graft polymers. The rubber-modified graft polymer B comprises a random (co)polymer formed from vinyl monomers B.1, preferably according to B.1.1 and B.1.2, and also a rubber B.2 that has been grafted with vinyl monomers, preferably according to B.1.1 and B.1.2. Preparation of B is effected in known manner by radical polymerization, for example in accordance with an emulsion, bulk or solution or bulk-suspension polymerization process, as described, for example, in U.S. Pat. No. 3,243,481, U.S. Pat. No. 3,509,237, U.S. Pat. No. 3,660,535, U.S. Pat. No. 4,221,833 and U.S. Pat. No. 4,239,863 all incorporated herein by reference. Particularly suitable graft rubbers are ABS polymers prepared by redox initiation with an initiator system consisting of organic hydroperoxide and ascorbic acid according to U.S. Pat. No. 4,937,285 incorporated herein by reference.

Preferred are one or more graft polymers of 5 to 99, preferably 20 to 98 wt. % of at least one vinyl monomer B.1 on 95 to 1, preferably 80 to 2 wt. % of one or more graft bases B.2 with glass transition temperatures<10° C., preferably<−10° C.

Preferred monomers B.1.1 are styrene, α-methylstyrene, halogen-substituted or alkyl-ring-substituted styrene such as p-methylstyrene, p-chlorostyrene, (meth)acrylic C₁-C₈ alkyl esters such as methyl methacrylate, n-butyl acrylate and tert-butyl acrylate. Preferred monomers B.1.2 are unsaturated nitriles such as acrylonitrile, methacrylonitrile, (meth)acrylic C₁-C₈ alkyl ester such as methyl methacrylate, n-butyl acrylate, tert-butyl acrylate, derivatives (such as anhydrides and imides) of unsaturated carboxylic acids such as maleic anhydride and N-phenylmaleimide or mixtures thereof.

Particularly preferred monomers B.1.1 are styrene, α-methylstyrene and/or methyl methacrylate; particularly preferred monomers B.1.2 are acrylonitrile, maleic anhydride and/or methyl methacrylate.

Particularly preferred monomers are B.1. 1 styrene and B.1.2 acrylonitrile.

Suitable rubbers B.2 for the rubber-modified graft polymers B are, for example, diene rubbers, acrylate rubbers, polyurethane rubbers, silicone rubbers, chloroprene rubbers and ethylene/vinyl-acetate rubbers. Composites formed from various of the stated rubbers are also suitable as graft bases.

Preferred rubbers B.2 are diene rubbers (for example, based on butadiene, isoprene etc.) or mixtures of diene rubbers or copolymers of diene rubbers or mixtures thereof with other copolymerizable vinyl monomers (e.g. according to B.1.1 and B.1.2), with the proviso that the glass transition temperature of component B.2 lies below 10° C., preferably below −10° C. Particularly preferred is pure polybutadiene rubber. Other copolymerizable monomers may be contained in the rubber base in a proportion up to 50 wt. %, preferably up to 30 wt. %, in particular up to 20 wt. % (relative to the rubber base B.2).

Suitable acrylate rubbers according to B.2 of the polymers B are preferably polymers formed from acrylic alkyl esters, optionally with up to 40 wt. %, relative to B.2, other polymerizable, ethylenically unsaturated monomers. The preferred polymerizable acrylic esters include C₁ to C₈ alkyl esters, for example methyl, ethyl, butyl, n-octyl and 2-ethylhexyl esters; halogen alkyl esters, preferably halogen C₁-C8 alkyl esters, such as chloroethyl acrylate and also mixtures of these monomers.

Particularly preferred are graft polymers according to the present invention not having a graft base based on ethylene/propylene rubbers (EPR) or on rubbers based on ethylene/propylene and on non-conjugated diene (EPDM). Such EPR or EPDM rubber based graft polymers are disclosed e.g. in JP 1 1241016A2.

Preferred “other” polymerizable, ethylenically unsaturated monomers, which in addition to the acrylic esters may optionally serve for preparing the graft base B.2, are, for example, acrylonitrile, styrene, α-methylstyrene, acrylamides, vinyl C₁-C₆ alkyl ethers, methyl methacrylate, butadiene. Preferred acrylate rubbers by way of graft base B.2 are emulsion polymers that have a gel content of at least 60 wt. %.

Further suitable graft bases according to B.2 are silicone rubbers with graft-active points, as described in DE-A 3 704 657, DE-A 3 704 655, DE-A 3 631 540 and DE-A 3 631 539.

The gel content of the graft base B.2 is determined at 25° C. in a suitable solvent (M. Hoffmann, H. Krömer, R. Kuhn, Polymeranalytik I und II, Georg Thieme-Verlag, Stuttgart 1977).

The mean particle size, d₅₀, is that diameter, above and below which 50 wt. % of the particles are distributed. It can be determined by means of ultracentrifuge measurement (W. Scholtan, H. Lange, Kolloid-Z. und Z. Polymere 250 (1972), 782-796).

Component B may, if required and if the rubber properties of component B.2 are not impaired thereby, additionally contain small amounts, ordinarily less than 5 wt. %, preferably less than 2 wt. %, relative to B.2, of residues of ethylenically unsaturated monomers having a crosslinking effect. Examples of such monomers having a crosslinking effect are esters of unsaturated monocarboxylic acids with 3 to 8 C atoms and of unsaturated monohydric alcohols with 3 to 12 C atoms, or of saturated polyols with 2 to 4 OH groups and 2 to 20 C atoms, polyunsaturated heterocyclic compounds, polyfunctional vinyl compounds such as alkylenediol di(meth)acrylates, polyester di(meth)acrylates, divinylbenzene, trivinylbenzene, trivinyl cyanurate, triallyl cyanurate, allyl (meth)acrylate, diallyl maleate diallyl fumarate, triallyl phosphate and diallyl phthalate.

Preferred crosslinking monomers are allyl methacrylate, ethylene glycol dimethacrylate, diallyl phthalate and heterocyclic compounds that have at least three ethylenically unsaturated groups.

In the case of preparation by means of bulk or solution or bulk-suspension polymerization, the rubber-modified graft polymer B is obtained by graft polymerization of 50 to 99, preferably 65 to 98, particularly preferably 75 to 97 parts by weight of a mixture consisting of 50 to 99, preferably 60 to 95 parts by weight monomers according to B.1.1 and 1 to 50, preferably 5 to 40 parts by weight monomers according to B.1.2 in the presence of 1 to 50, preferably 2 to 35, particularly preferably 2 to 15, in particular 2 to 13 parts by weight of the rubber component B.2.

The mean particle diameter d₅₀ of the grafted rubber particles is in the range of 0.05 to 10 μm, preferably 0.1 to 5 μm, particularly preferably 0.2 to 1 μm.

The mean particle diameter d₅₀ of the resulting grafted rubber particles, which are obtainable by bulk or solution or bulk-suspension polymerisation processes (ascertained by enumeration in respect of electron micrographs) generally lies within the range from 0.5 μm to 5 μm, preferably from 0.8 μm to 2.5 μm.

Component B may include one or a mixture of several graft copolymers.

Component B is preferably contained in the polymer composition according to the invention in a quantity from 0.5 to 50 parts by weight, particularly preferably from 1 to 35 parts by weight, and quite particularly preferably from 5 to 25 parts by weight.

Component C

Mineral particles that are suitable in accordance with the invention are inorganic materials having imbricated or lamellar character, such as talc, mica/clay-bank minerals, montmorillonite, the latter also in an organophilic form modified by ion exchange, furthermore kaolin and vermiculite.

Talc is particularly preferred. The term ‘talc’ is understood to mean a naturally occurring or synthetically produced talc. Pure talc has the chemical composition 3MgO.4SiO₂.H₂O and consequently an MgO content of 31.9 wt. %, an SiO₂ content of 63.4 wt. % and a content of chemically bound water of 4.8 wt. %. It is silicate with layered structure.

Particularly preferred are talc types of high purity. The latter contain, for example, an MgO content from 28 to 35 wt. %, preferably 30 to 33 wt. %, particularly preferably 30.5 to 32 wt. % and an SiO₂ content from 55 to 65 wt. %, preferably 58 to 64 wt. %, particularly preferably 60 to 62.5 wt. %. Preferred talc types are distinguished furthermore by an A1₂0₃ content of<5 wt. %, particularly preferably<1 wt. %, in particular<0.7 wt. %.

Preferred mineral particles are, furthermore, also those with anisotropic particle geometry. This is understood to mean those particles, the so-called aspect ratio of which—the ratio of the largest and smallest particle diameters13 is greater than 1, preferably greater than 2 and particularly preferably greater than about 5. Such particles are, at least in the broadest sense, lamellar or fibriform. Such materials include, for example, certain talcs and certain (alumino)silicates with stratified or fibrous geometry, such as bentonite, wollastonite, mica, kaolin, hydrotalcite, hectorite or montmorillonite.

Also advantageous, in particular, is talc in the form of finely ground powder having a mean particle size, d₅₀, of<10 μm, preferably<5 μm, particularly preferably<2.5 μm, quite particularly preferably≦1.5 μm. Preferred in particular is the use of talc with a mean particle size d50 from 350 nm to 1.5 μm.

Particle size and particle diameter in the sense of this invention signify the mean particle diameter d₅₀, ascertained by ultracentrifuge measurements according to W. Scholtan et al., Kolloid-Z und Z. Polymere 250 (1972), pp 782-796.

Furthermore, the mineral particles may be surface-modified with organic molecules, for example silanized,.in order to achieve a better compatibility with the polymers. In this way it is possible for hydrophobic or hydrophilic surfaces to be generated.

Ultrafine mineral particles with anisotropic geometry that are particularly appropriate for use in the composition according to the invention are furthermore the inorganic materials described in U.S. Pat. No. 5,714,537 and U.S. Pat. No. 5,091,461 incorporated herein by reference.

In this connection talc, clay or a material of similar type that have a number-average particle size of≦10 μm and a ratio of average diameter to thickness (D/T) from 4 to 30 are particularly suitable.

As described in U.S. Pat. No. 5,091,461, in particular elongated or plate-like materials having the specified small particles are suitable in comparison with fibrillar or spherical fillers. Highly preferred are those compositions which contain particles that have a ratio of average diameter to thickness (D/T), measured in accordance with the way described in U.S. Pat. No. 5,714,537, of at least 4, preferably at least 6, more preferably at least 7. With regard to the maximum value of the ratio D/T, it has been found desirable to have a value up to and including 30, preferably up to and including 24, more preferably up to and including 18, still more preferably up to and including 13, and most preferably up to and including 10.

The mineral particles may be present in the form of powders, pastes, sols, dispersions or suspensions. Powders may be obtained from dispersions, sols or suspensions by precipitation.

The materials may also be worked into the thermoplastic molding compositions in accordance with conventional processes, for example by direct kneading or extrusion of molding compositions and the ultrafine-particle inorganic powders. Preferred processes are constituted by the production of a master batch, for example in flameproofing additives, and at least one component of the molding compositions according to the invention in monomers or solvents, or the coprecipitation of one thermoplastic component and the ultrafine-particle inorganic powders, for example by coprecipitation of an aqueous emulsion and the ultrafine-particle inorganic powders, optionally in the form of dispersions, suspensions, pastes or sols of the ultrafine-particle inorganic materials.

Examples of substances that may be preferentially employed in accordance with the invention as mineral particles are Tremin® 939-300EST, produced by Quarzwerke GmbH, Frechen, Germany (aminosilane-coated wollastonite with a mean needle diameter of 3 μm), Finntalc® M30SL, produced by Omya GmbH, Cologne, Germany (uncoated talc with a particle size d₅₀=8.5 μm), Wicroll® 40PA, produced by Omya GmbH, Cologne, Germany (silanised wollastonite with a particle size d₅₀=1.3 μm) and also Burgess® 2211, produced by Omya GmbH, Cologne, Germany (aminosilane-coated aluminium silicate with a particle size d₅₀=1.3 μm), Naintsch A3 (see Examples, Component C), Nyglos® 4-10013 (silanized wollastonite with a particle size d₅₀=4.8 μm), produced by NYCO Minerals Inc. Willboro, N.Y., USA.

The mineral particles of component C may be contained in the composition according to the invention in a quantity of preferably up to 30 parts by weight, particularly preferably up to 20 parts by weight and, if included, preferably from 1.5 to 15 parts by weight.

Component D

Component D) in accordance with the invention is a particulate carbon compound such as carbon black, which is suitable for establishing conductivity and is also designated by those skilled in the art as conductive carbon black, graphite powders and/or carbon nanofibrils.

According to the invention, in the case of graphite powders it is comminuted graphite. A person skilled in the art understands graphite to be a modification of carbon, as described, for example, in A. F. Hollemann, E. Wieberg, N. Wieberg, Lehrbuch der anorganischen Chemie, 91st-100th Edn., pp 701-702. Graphite consists of planar carbon layers which are arranged above one another.

According to the invention, graphite may, for example, be comminuted by grinding. The particle size is within the range of 0.1 μm-1 mm, preferably 1 to 300 μm, most preferably 2 to 20 μm.

In the case of conductive carbon blacks according to the invention, the primary-particle size is between 0.005 μm and 0.2 μm, preferably between 0.01 μm and 0.1 μm. The dibutyl-phthalate adsorption of the conductive carbon blacks is between 40 ml and 1000 ml per 100 g carbon black, preferably between 90 ml and 600 ml per 100 g carbon black. A large number of oxygen-bearing groups, such as, for example, carboxyl, lactol, phenol groups, quinoid carbonyl groups and/or pyrone structures, may be located on the surface of the carbon black.

Conductive carbon blacks may, for example, be produced from acetylene, from synthesis gas or from the furnace process from oil, carrier gases and air. Production processes are described, for example, in R. G. Gilg, Ruβ für leitfähige Kunststoffe in: Elektrisch leitende Kunststoffe, Editors: H. J. Mair, S. Roth, 2^{nd} edition, Carl Hanser Verlag, 1989, Munich, Vienna, pp 21-36 and in the literature cited therein.

Addition of the carbon blacks and/or graphites according to the invention may be effected before, during or after the polymerization of the monomers to form the thermoplastic of component A). If addition of the carbon blacks and/or graphites according to the invention is effected after the polymerization, it is preferably effected by addition to the thermoplastic melt in an extruder or in a kneader. According to the invention, the carbon blacks and/or graphites may also be added in metered amounts in the form of highly concentrated master batches in thermoplastics which are preferably chosen from the group comprising the thermoplastics employed as component A). The concentration of the carbon blacks and/or graphites in the master batches lies within the range from 5 to 70, preferably 8 to 50, particularly preferably within the range from 12 to 30 wt. %, relative to the master batch. The carbon blacks and/or graphites may, for the purpose of better meterability, also be added to binding agents such as, for example, waxes, fatty-acid esters or polyolefins. They may also be pelletized or granulated with or without additional binding agents, for example by press-molding or compression processes, which likewise serves for better meterability.

Carbon nanofibrils according to the invention typically have the form of tubes which are formed from layers of graphite. The graphite layers are disposed around the axis of the cylinder in concentric manner.

Carbon nanofibrils have a length-to-diameter ratio of at least 5, preferably at least 100, particularly preferably at least 1000. The diameter of the nanofibrils typically lies within the range from 0.003 μm to 0.5 μm, preferably within the range from 0.005 μm to 0.08 μm, particularly preferably within the range from 0.006 μm to 0.05 μm. The length of the carbon nanofibrils typically amounts to 0.5 μm to 1000 μm, preferably 0.8 μm to 100 μm, particularly preferably 1 μm to 10 μm. The carbon nanofibrils possess a hollow, cylindrical core, around which the graphite layers are formally wound. This hollow space typically has a diameter from 0.001 μm to 0.1 μm, preferably a diameter from 0.008 μm to 0.015 μm. In a typical embodiment of the carbon nanofibrils the wall of the fibril around the hollow space consists, for example, of eight graphite layers. The carbon nanofibrils may in this case be present in the form of aggregates with a diameter up to 1000 μm, preferably with a diameter up to 500 μm, consisting of several nanofibrils. The aggregates may have the form of birds' nests, of combed yarn or of open net structures.

Addition of the carbon nanofibrils may be effected before, during or after the polymerization of the monomers to form the thermoplastic of component A). If addition of the carbon nanofibrils is effected after the polymerization, it is preferably effected by addition to the thermoplastic melt in an extruder or in a kneader. As a result of the compounding process in the kneader or extruder, in particular the aggregates already described may be largely or even totally comminuted and the carbon nanofibrils may be dispersed in the thermoplastic matrix.

In a preferred embodiment the carbon nanofibrils may be added in metered amounts in the form of highly concentrated master batches in thermoplastics which are preferably chosen from the group comprising the thermoplastics employed as component A). The concentration of the carbon nanofibrils in the master batches lies within the range from 5 to 50, preferably 8 to 30, particularly preferably within the range from 12 to 22 wt. %, relative to the master batch. The production of master batches is described in U.S. Pat. No. 5,643,502, for example. Through the use of master batches, in particular the comminution of the aggregates may be improved. Due to the processing to form the molding composition or molded article, the carbon nanofibrils may exhibit shorter length distributions in the molding composition or in the molded article than originally employed.

In a preferred embodiment, use may also be made of mixtures of the individual components.

Conductive carbon blacks according to the invention may, for example, be procured under the name Ketjenblack® from AKZO Nobel, under the name Vulcan® from Cabot or under the name Printex® from Degussa.

Graphites according to the invention may be procured in the form of powders, for example from Vogel & Prenner Nachf., Wiesbaden, Germany.

Carbon nanofibrils are offered for sale, for example, by Hyperion Catalysis or by Applied Sciences Inc. Synthesis of the carbon nanofibrils is effected, for example, in a reactor that contains a carbon-containing gas and a metal catalyst, as described in U.S. Pat. No. 5,643,502, for example.

Component E

Thermoplastic polymers with polar groups are preferably employed by way of compatibility promoter according to component E).

According to the invention suitable polymers contain the polymerized derivatives of

E.1 a vinyl aromatic monomer,

E.2 at least one monomer selected from the group consisting of C₂ to C₁₂ alkyl methacrylates, C₂ to C₁₂ alkyl acrylates, methacrylonitriles and acrylonitriles and

E.3 α,β-unsaturated moieties containing dicarboxylic anhydrides.

Styrene is particularly preferred vinyl aromatic monomer E.1; acrylonitrile is particularly preferred component E.2; maleic anhydride is particularly preferred E.3.

Terpolymers of the stated monomers are preferably employed by way of components E.1, E.2 and E.3. Accordingly, terpolymers of styrene, acrylonitrile and maleic anhydride preferably used. These terpolymers contribute, in particular, to improvement of the mechanical properties such as tensile strength and elongation at rupture. The quantity of maleic anhydride in the terpolymer may vary within wide limits. The quantity preferably amounts to 0.2 to 5 mol %. Particularly preferred are quantities between 0.5 and 1.5 mol %. Within this range particularly good mechanical properties are achieved with respect to tensile strength and elongation at rupture.

The terpolymer may be prepared in a known manner. A suitable method is the dissolution of monomer components of the terpolymer, for example of the styrene, maleic anhydride or acryonitrile, in a suitable solvent, for example methyl ethyl ketone (MEK). To this solution there are added one or more chemical initiators. Suitable initiators are, for example, peroxides. Then the mixture is polymerized for several hours at elevated temperatures. Subsequently the solvent and the unreacted monomers are removed in a known manner.

The ratio of component E.1 (vinyl aromatic monomer) to component E.2, for example the acrylonitrile monomer, in the terpolymer is preferably between 80:20 and 50:50. In order to improve the miscibility of the terpolymer with the graft copolymer B, a quantity of vinyl aromatic monomer E.1 is preferably selected that corresponds to the quantity of the vinyl monomer B.1 in the graft copolymer B.

Examples of compatibility promoters E that may be employed in accordance with the invention are described in EP-A 785 234 and EP-A 202 214 (corresponding respectively to U.S. Pat. Nos. 5,756,576 and 4,713,415 the specifications of which are incorporated herein by reference). Preferred in accordance with the invention are, in particular, the polymers named in EP-A 785 234.

The compatibility promoters may be used singly or as mixtures of two or more such promoters.

Another substance which is particularly preferred by way of compatibility promoter is a terpolymer of styrene and acrylonitrile in a weight ratio 2.1:1 containing 1 mol % maleic anhydride.

The quantity of component E in the polymer compositions according to the invention preferably lies between 0.5 and 30 parts by weight, in particular between 1 and 20 parts by weight and, particularly preferably, between 2 and 10 parts by weight. Most highly preferred are quantities between 3 and 7 parts by weight.

Component F

Component F is one or more thermoplastic vinyl (co)polymers.

Suitable vinyl (co)polymers are polymers of at least one monomer selected from the group consisting of vinyl aromatics, vinyl cyanides (unsaturated nitriles), (meth)acrylic (C₁-C₈) alkyl esters, unsaturated carboxylic acids and also derivatives (such as anhydrides and imides) of unsaturated carboxylic acids. Particularly suitable are (co)polymers formed from

F.1 50 to 99, preferably 60 to 80 parts by weight vinyl aromatics and/or ring-substituted vinyl aromatics (such as styrene, α-methylstyrene, p-methylstyrene, p-chlorostyrene) and/or methacrylic (C₁-C₈) alkyl esters (such as methyl methacrylate, ethyl methacrylate), and

F.2 1 to 50, preferably 20 to 40 parts by weight vinyl cyanides (unsaturated nitriles) such as acrylonitrile and methacrylonitrile and/or (meth)acrylic (C₁-C₈) alkyl esters (such as methyl methacrylate), n-butyl acrylate, tert-butyl acrylate) and/or imides of unsaturated carboxylic acids (e.g. N-phenylmaleimide).

The (co)polymers F are resinous, thermoplastic and rubber-free. Particularly preferred is the copolymer formed from F.1 styrene and F.2 acrylonitrile.

The (co)polymers F are known and may be prepared by radical polymerization, in particular by emulsion, suspension, solution or bulk polymerization. The (co)polymers preferably possess mean molecular weights Mw (weight average, ascertained by light scattering or sedimentation) between 15,000 and 200,000.

The vinyl (co)polymers of component F may be used singly or in arbitrary mixture with one another.

Component F is preferably contained in the polymer composition in a quantity from 0 to 30 parts by weight, in particular from 0 to 25 parts by weight and, particularly preferably, from 0 to 20 parts by weight, in particular 0 to 10 parts by weight.

Component G

The polymer compositions according to the invention may contain conventional additives that are known in the art for their function in the context of polyamide molding compositions. These include flameproofing agents, anti-dripping agents, lubricants, mould-release agents, nucleating agents, anti-static agents, stabilisers, filling and reinforcing materials different from component C as well as dyestuffs and pigments and hydrophobing agents such as phenolformaldehyde resins.

The compositions according to the invention may generally contain 0.01 to 20 parts by weight, relative to the overall composition, flameproofing agents. Named in exemplary manner by way of flameproofing agents are organic halogen compounds such as decabromobisphenyl ether, tetrabromobisphenol, inorganic halogen compounds such as ammonium bromide, nitrogen compounds such as melamine, melamineformaldehyde resins, inorganic hydroxide compounds such as Mg—Al hydroxide, inorganic compounds such as aluminium oxides, titanium dioxides, antimony oxides, barium metaborate, hexahydroxoantimonate, zirconium oxides zirconium hydroxide, molybdenum oxide, ammonium molybdate, tin borate, ammonium borate and tin oxide as well as siloxane compounds.

By way of flameproofing compounds, furthermore phosphorus compounds as described in EP-A 363 608, EP-A 345 522 (corresponding to U.S. Pat. No. 5,061,745) and/or EP-A 640 655—all incorporated herein by reference may be employed.

By way of further filling and reinforcing materials, those which are different from component C) suitable are, for example, glass fibers, optionally cut or ground, glass beads, glass bulbs, silicates, quartz and titanium dioxide or mixtures thereof. Cut or ground glass fibers are preferably employed as reinforcing material.

Suitable hydrophobing agents are, for example, phenolformaldehyde resins. They are prepared by condensation reaction of phenols with aldehydes, preferably formaldehyde, by derivatization of the condensates resulting thereby or by addition of phenols to unsaturated compounds, such as, for example, acetylene, terpenes etc. Condensation may in this case be effected in the acidic or basic range, and the molar ratio of aldehyde to phenol may amount to from 1:0.4 to 1:2.0. In the process, oligomers or polymers with a molar mass from 150 to 5000 g/mol arise. The molding compositions preferably contain phenol-formaldehyde resins, which are generally added in a quantity of up to 15, preferably 1 to 12 and in particular 2 to 8 parts by weight.

All data relating to parts by weight in this application should be normalised in such a way that the sum of the parts by weight of all the components is set equal to 100.

The compositions according to the invention are prepared by mixing the respective constituents in known manner and by melt-compounding and melt-extruding at temperatures of 200 to 300° C. in conventional units such as internal kneaders, extruders and twin-rotor screws, the mold-release agent being employed in the form of a coagulated mixture.

Mixing of the individual constituents may be effected in known manner both successively and simultaneously, both at about 20° C. (room temperature) and at higher temperature.

The polymer compositions according to the invention may be used for producing moldings of any type. In particular, moldings can be produced by injection molding. Examples of moldings are: casing parts of any type, for example for household appliances such as electric shavers, flat screens, monitors, printers, copiers, or cover plates for the construction industry, and parts for motor vehicles and rail vehicles. In addition, they can be employed in the field of electrical engineering, because they have very good electrical properties.

Moreover, the polymer compositions according to the invention can, for example, be used for the purpose of producing the following moldings:

Interior finishing parts for rail vehicles, ships, buses, other motor vehicles and aircraft, wheel caps, casings of electrical equipment containing small transformers, casings for instruments for the dissemination and transmission of information, planar wall elements, casings for security devices, rear spoilers and other bodywork parts for motor vehicles, thermally insulated transit containers, devices for keeping or taking care of small animals, cover grilles for ventilator openings, mouldings for summerhouses and tool sheds, casings for gardening implements.

Another form of processing is the production of mouldings from previously produced sheets or films by thermoforming.

The present invention therefore further provides also the use of the compositions according to the invention for the production of mouldings of any type, preferably the aforementioned, as well as the moldings consisting of the compositions according to the invention.

By reason of the excellent online lacquerability, the present invention provides the online-lacquered moldings, preferably online-lacquered exterior parts for motor vehicles, for example wheel housings, wings, exterior mirror housings etc.

The following Examples serve for further elucidation of the invention.

### EXAMPLES

In accordance with the data of Table 1, the compositions are produced, processed further into test specimens and tested.

Component A1

Polyamide 66 (Ultramid® A3, BASF, Ludwigshafen, Germany).

Component A2

Noryl® GTX974, a blend containing polyamide and polyphenylene ether, a product of General Electric Plastics, Bergen op Zoomen, Netherlands.

Component B

Graft polymer of 40 parts by weight of a copolymer formed from styrene and acrylonitrile in a ratio of 73:27 onto 60 parts by weight of polybutadiene rubber crosslinked in particulate manner (mean particle diameter d₅₀=0.28 μm), produced by emulsion polymerization.

Component C

Naintsch A3 (Naintsch Mineralwerke GmbH, Graz, Austria). Talc with a mean particle diameter (d₅₀), according to the manufacturer's data, of 1.2 μm.

Component D

Ketjenblack® EC 600 (Akzo Nobel, Verkaufsbüro Düren, 52349 Düren, Germany) (electrically conductive carbon black).

Component E

Terpolymer of styrene and acrylonitrile with a weight ratio of 2.1:1 containing 1 mol % maleic anhydride.

Component F

Styrene/acrylonitrile copolymer with a styrene/acrylonitrile weight ratio of 72:28 and with an intrinsic viscosity of 0.55 dl/g (measurement in dimethylformamide at 20° C.).

Component G

For additives G.1 and G.2, see Table 1.

G.3: Rhenosin® RB (phenolformaldehyde resin), Rhein Chemie Rheinau GmbH, Mannheim.

Production and Testing of the Molding Compositions According to the Invention

Mixing of the components of the compositions is effected using a 3 1 internal kneader. The molded articles are produced in an injection-molding machine of type Arburg 280E at 260° C.

Determination of the HDT thermal stability is in accordance with ISO R 75.

Determination of the coefficient of expansion lengthwise (10⁻⁴×K⁻¹) is in accordance with ASTM E 831.

With a view to determining the optical shrinkage measurement a 60×60×2 mm sheet at a material temperature of 280° C., at a pressure of 500 bar and at a tool temperature of 80° C. is injected. This sheet is then immediately measured in the longitudinal and transverse directions, is subsequently annealed for 1 h at 80 ° C. and then measured again. The difference in the length measurements is indicated in % as length shrinkage and width shrinkage. This procedure is repeated five times, and the mean value is stated.

The results of the individual tests are summarised in Table 1.

TABLE 1

| | | Comparison 1 | 2 |
|---|---|---|---|
| Example/ | | | |
| Components | | | |
| A1 | Polyamide 66 | | 60.09 |
| A2 | Noryl ® GTX 974 | 100 | |
| B | Graft polymer | | 18.28 |
| C | Talc | | 3.93 |
| D | Carbon black | | 3.93 |
| E | Compatibility promoter | | 4.71 |
| F | Styrene/acrylonitrile | | 2.59 |
| | copolymer | | |
| G1 | Mould-release agent | | 0.24 |
| G2 | Stabilisers | | 1.29 |
| H | Phenolformaldehyde resin | | 4.91 |
| Properties | | | |
| Modulus of | [MPa] | 2200 | 3100 |
| elasticity | | | |
| HDT B | [° C.] | 167 | 170 |
| Shrinkage | [%] | 1.3 | 1.16 |
| Coefficient of | 10⁻⁴/K | 0.99/1.00 | 0.88/0.96 |
| thermal | | | |
| expansion¹⁾ | | | |
| Surface | | OK²⁾ | OK |
| Surface | [Ω] | 2.5E+8 | 3.8E+7 |
| resistivity³⁾ | | | |

¹⁾longitudinal/transverse
²⁾Class A
³⁾according to DIN IEC 60 167

Both Example 1 according to the invention and Comparative Example 1 are assessed as regards the quality of the lacquer coating in an ESTA (electrostatic) lacquering plant with 11 μm within the margins of error as being comparable with steel and therefore OK.

With the same quality of the applied layer of lacquer the molding composition according to the invention displays a clearly higher stiffness (modulus of elasticity), better shrinkage behavior and a better coefficient of thermal expansion.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A molding composition containing polyamide, 0.1 to 8 parts by weight of electrically conductive carbon in particulate form and 0.5 to 50 parts by weight of a graft polymer, the sum of the parts by weight of the polyamide, conductive carbon and graft polymer totalling 100.

2. A molding composition containing polyamide, 0.1 to 8 parts by weight of electrically conductive carbon in particulate form, 0.5 to 50 parts by weight of a graft polymer and up to 30 parts by weight mineral particles the sum of the parts by weight of the polyamide, conductive carbon, graft polymer and mineral particles totalling 100.

3. A molding composition containing polyamide, 0.1 to 8 parts by weight of electrically conductive carbon in particulate form, 0.5 to 50 parts by weight of a graft polymer, up to 30 parts by weight mineral particles and at least one further component selected from the group consisting of compatibility promoters, vinyl (co)polymers, polymer additives and phenolformaldehyde resins, the sum of the parts by weight of the polyamide, conductive carbon, graft polymer, mineral particles and the further component totalling 100.

4. A thermoplastic molding composition comprising
A) 40 to 90 parts by weight polyamide
B) 0.5 to 50 parts by weight graft polymer
C) 0.1 to 30 parts by weight mineral particles
D) 0.1 to 8 parts by weight electrically conductive carbon particles the sum of the parts by weight of A) through D) totalling 100.

5. The composition according to claim 1, wherein the graft polymer contains the polymerized product of at least one vinyl monomer grafted on at least one graft base having glass transition temperature<10° C.

6. The composition according to claim 1 wherein the graft polymer is the product of polymerizing at least one monomer selected from the group B.1.1 consisting of styrene, α-methylstyrene, halogen-substituted or alkyl-ring-substituted styrenes, (meth)acrylic C₁-C₈ alkyl esters and at least one monomer selected from the group B.1.2 consisting of unsaturated nitrites, (meth)acrylic C₁-C₈ alkyl esters and derivatives of unsaturated carboxylic acids, grafted on a graft base having glass transition temperature≦10° C.

7. The composition according to claim 5, wherein the graft base is at least one member selected from the group consisting of diene rubbers, copolymers of diene rubbers, acrylate rubbers, polyurethane/silicone rubbers, chloroprene rubbers and ethylene/vinyl-acetate rubbers.

8. The composition according to claim 5, wherein the graft base is at least one member selected from the group consisting of diene rubbers, copolymers of diene rubbers and acrylate rubbers.

9. The composition according to claim 5 wherein the graft base is polybutadiene.

10. The composition according to claim 1, wherein the electrically conductive carbon is selected from the group consisting of carbon black, graphite and carbon nanofibrils.

11. The composition according to claim 2, wherein the mineral particles are selected from the group consisting of talc, mica, clay-bank minerals, montmorillonite, kaolin, vermiculite and wollastonite.

12. The composition according to claim 2 wherein mineral particles are talc.

13. The composition according to claim 3 wherein the further component is phenolformaldehyde resin, that is present in an amount of 1 to 12 parts by weight.

14. The composition according to claim 3 wherein compatibility promoter is a copolymer formed from
E.1 a vinyl aromatic monomer,
E.2 at least one monomer selected from the group consisting of C2 to C₁₂ alkyl methacrylates, C₂ to C₁₂ alkyl acrylates, acrylonitrile and methacrylonitrile and
E.3 at least one α,β-unsaturated component containing dicarboxylic anhydride.

15. A molded article comprising the composition of claim 1.

16. A molded article comprising the composition of claim 4.
